(19) United States
(12) Patent Application Publication
(10) Pub. No.: US 2002/0084619 A1
(43) Pub. Date: Jul. 4, 2002

(54) Vehicle front suspension system

(76) Inventor: Harold Paul Odom, Hawthorn Woods, IL (US)

Correspondence Address: H. PAUL ODOM, 9 ORCHARD LANE, HAWTHORN WOODS, IL, 60047, US

(21) Appl. No.: 09/927,870

(22) Filed: Aug. 9, 2001

Related U.S. Application Data
(60) Provisional application No. 60/224,883, filed on Aug. 14, 2000.

(51) Int. Cl. B62K 1/00; B62M 5/00

(52) U.S. Cl. 280/276; 280/274

(57) ABSTRACT

A motorcycle is disclosed having a handlebar support system that is designed to move the handlebar in the opposite direction, relative to the frame, from the front wheel, when the front wheel responds to bumps. A parallelogram linkage supports the handlebar of the motorcycle in a way that allows the handlebar to reversibly move through a generally vertical path relative to the sprung portion of the vehicle. A linkage means reversibly converts the upward motion of the front wheel suspension system of the motorcycle to downward motion of the handlebar, through the parallelogram linkage. As the front suspension compresses in response to bumps, the handlebar moves downward, thus compensating for the upward motion of the main frame of the vehicle that the front suspension could not absorb.

### FIELD OF THE INVENTION

The field of the invention includes motorcycles, bicycles, tricycles, all terrain vehicles (ATVs), snowmobiles and any other vehicles and systems that utilize a suspension system to isolate a rider's or operator's hands from disturbances.

### BACKGROUND OF THE INVENTION

Vehicles such as bicycles and motorcycles often utilize suspension systems to isolate the rider from impacts that the front wheel receives. The most common form of front suspension for motorcycles and bicycles is a pair of telescoping tubes with internal springs, that support the front wheel axle on each of its ends. As with all front suspension systems, the front wheel itself can then move in a generally vertical direction relative to the main frame of the vehicle so as to reduce the impact of shocks on the main frame of the vehicle and on the rider.

Many motorcycles and bicycles are designed in a way that causes the rider to support much of his upper body weight with his hands when riding normally. Reducing the shocks to the rider's hands on such vehicles significantly improves comfort of the muscles and joints of the rider's hands, arms, and upper body. In recent years, the part of the bicycle that supports the handlebar, known as the stem, has been modified by some manufacturers in a way that allows the handlebar assembly to be pushed downward by the rider, in an attempt to reduce these shocks on the rider. This downward motion of the handlebar relative to the vehicle's frame is reversible, and occurs as the rider briefly exerts the considerably increased downward forces on the handgrips that result from intermittent upward acceleration of the rider's mass supported by his hands under bumpy riding conditions. A spring is utilized to restore the stem and handlebar to their original positions, and is often used in conjunction with a damping means. This type of system can not work unless the rider's hands transmit significantly higher than average forces to the handlebar for brief moments of time, putting energy into the spring, and also providing enough additional energy to overcome the friction of the system. While this type of system may be better than a rigidly mounted handlebar, the obvious result is still an increase in the stress levels in the rider's hands, wrists, arms, and upper body as the stem deflects, and as it then restores itself to its original position.

Off road vehicles such as motocross motorcycles are relatively prone to impacting the ground with considerable force after being driven over large bumps or jumps. The front handgrips transmit upward force to the rider's hands, wrists, arms, and upper body when these impacts occur. A condition called “arm pump” frequently makes riding off-road motorcycles very fatiguing to the rider's arms specifically, and to the rider generally, as a result of the repetitive and sometimes violent up and down motion of the handlebars while riding over rough terrain. This is especially true in racing situations, and commonly leads to diminished rider performance.

Current front suspension systems typically achieve all of their effective travel by supporting the wheel far enough away from the vehicle frame with the suspension in a relatively unloaded condition, to allow for the desired suspension travel without causing wheel to frame, or related interference when high suspension loads are encountered. For aggressive off-road riding, more suspension travel is generally considered better, except for the associated frame geometry compromises, higher center of gravity, and the additional weight of longer travel suspension components. Expanding the front wheel suspension system to include the front handlebar actually allows the suspension designer to use a shorter travel wheel suspension system, without sacrificing the shock isolation effectiveness of a longer travel suspension.

While both front wheel suspension systems and handlebar suspension systems each offer certain benefits, there is a need for an integrated front suspension system that uses the displacement of the front wheel suspension system to actively control a handlebar suspension system. There is a need for a system in which a mechanical link or analogous means is used to effect motion of the handlebar in response to changes in the displacement of a wheel suspension system, reversibly moving the handlebar to compensate for the upward motion of the front of the vehicle's frame, thereby minimizing or preventing increased stresses on the rider.

### SUMMARY OF THE INVENTION

This invention is for a means to supplement the front suspensions of ATVs, bicycles, motorcycles, and similar vehicles. It allows the handgrips on each end of the handlebar to reversibly move downward when the unsprung portion of the front suspension is displaced upward.

This invention replaces the standard rigidly mounted handlebars typically used today, with a parallelogram or four bar linkage that connects the handlebar or handgrips to the steering head of the vehicle. A parallelogram linkage allows the handgrips to move generally up and down, while not significantly changing the angle of the grips in the rider's hands. Such a linkage can also be designed to include fore and aft motion of the handgrips. In several preferred embodiments of this invention, the handgrips are located on a handlebar, which in turn is supported by a parallelogram linkage connected to the frame of the vehicle's steering assembly, thus allowing a vertical degree of freedom to the handgrips. The parallelogram linkage that controls the position of the handlebar is coupled to the front suspension by a linkage means in such a way that when the front suspension is compressed, the handgrips move generally downward relative the frame of the vehicle. There is also a corresponding upward motion of the handgrips that restores them to their original position relative to the vehicle frame as the front suspension compression is reversed. When such a system is properly designed, the suspension controlled motion of the handgrips extends the effective travel of the front suspension, and neutralizes or mitigates jolts to the rider's hands, thereby enhancing rider comfort, control, and safety.

The handgrip suspension system of this invention can also be made easily adjustable to better suit different riding styles, conditions, and front suspension stiffness settings.

While the use of parallelogram linkages for mounting handlebars are a part of the prior art, they have only been used in conjunction with a passive spring and/or damper, and have not been directly influenced by the front suspension.

Four bar linkages, such as parallelogram linkages, can be used to design in desirable changes of the angle of the moving handgrips in the rider's hands, in conjunction with, or independent of, vertical or horizontal motion of the handgrips. Depending on the linkage connecting the handlebar to the front fork, the motion of the handgrips can also be fore and aft, or comprise some combination of horizontal and vertical motion. It is also possible to pivotally link the handlebar to the upper part of the front suspension fork with a double ended link member, instead of a parallelogram linkage, although that would not prevent any rotation of the handlebar as it translated in response to front suspension motion. Means other than a parallelogram or four bar linkage are available for facilitating vertical and/or horizontal motion of the handlebar or handgrips relative to the vehicle frame are available. For example, a sliding shaft or pin in groove system could be used to support the handlebar. Pivoting link handlebar support means are preferable in most cases due to their simplicity and durability.

### BRIEF DESCRIPTION OF THE DRAWINGS

FIG. 1 is a side elevational view of a the front handlebar assembly and the front wheel suspension system which includes a simple linkage embodiment of the present invention.

FIG. 2 is a side elevational view of the front section of a vehicle that includes a front suspension motion attenuation linkage to control the handlebar.

FIG. 2a is identical to FIG. 2 except for the arrangement of the parallelogram linkage which supports the handlebar.

FIG. 3 is a side elevational view of the front of a two wheeled vehicle wherein elements of the linkage are repositioned to better avoid frame interference.

FIG. 3a is a side elevational view of the a vehicle section wherein the parallelogram linkage of FIG. 3 is simplified.

FIG. 4 is a side elevational view of a front wheel suspension system disclosing and alternative linkage means of the present invention.

FIG. 5 is a front elevational view of a front wheel and handlebar suspension system.

FIG. 6 is a side elevational view of a front wheel suspension system which utilizes a piston-cylinder means to control the handlebar motion.

FIG. 7 is a front elevational view of the front suspension system of an All Terrain Vehicle (ATV). A means for connecting the handlebars of the ATV to front suspension components is disclosed wherein the reversible upward motion of the front wheel suspension system causes reversible downward motion of the handgrips.

### DETAILED DESCRIPTION OF THE DRAWINGS

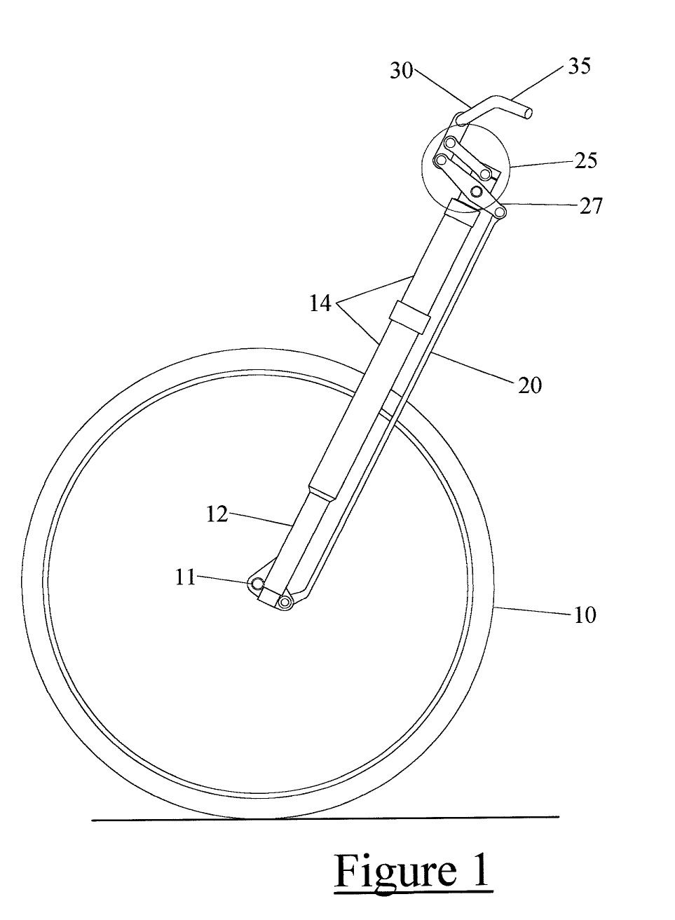

FIG. 1 is a side elevational view of the front suspension and handlebar system of a two wheeled vehicle such as a bicycle. The main frame of the vehicle is not shown as it is not significant in terms if the present invention. FIG. 1 shows a traditional handlebar 30 that is rigidly connected to a parallelogram linkage 25 that operates through a range of motion in a plane parallel with, or co-planar with, the plane of the front wheel 10. In FIG. 1, a front wheel 10 is rotatively supported by a front wheel axle 11, which in turn is supported by a pair of fork sliders 12. Said sliders are attached to, and constrained by, the upper fork assembly tubes 14, so that their upper portions can slide in and out of said upper fork assembly tubes 14, in response to inputs in the form of ground surface irregularities.

A connector link 20 is pivotally attached at its lower end to fork slider 12. The connector link 20 is generally parallel with the upper fork assembly tube 14, as shown in FIG. 1. Connector link 20 is also pivotally attached to a rear parallelogram link extension 27. Connector link 20 imparts a generally upward motion to the rear parallelogram link extension 27 in response to the generally upward motion of the front wheel 10 and fork slider 12. The generally upward motion of the rear parallelogram link extension 27 causes a corresponding motion of the forward portion of the parallelogram linkage 25 and the handlebar 30 attached thereto, that is generally downward. The aforementioned suspension and link motions are all reversible during the normal operation of the front suspension. The system functions to provide a degree of downward motion of the handlebar 30 and handgrips 35 in response to upward motion of front wheel 10 and fork slider 12, and vice versa.

It is important to note that a great many variations of this linkage are possible, and the linkage of FIG. 1, or other linkages of the current invention, or certain elements of them, do not need to be mounted to the vehicle in the fashion or location shown in FIG. 1 or the other figures in order to be functional. For example, it is also possible to utilize a rack and pinion to transfer linear motion of the lower front suspension into rotational motion of a link of the parallelogram linkage.

It should also be noted that some motorcycle front suspensions use pivoting rather than telescopically sliding elements to support the front wheel. While such alternative designs would not have an element that slides back and forth relative to another element, the slider 12 of this embodiment would be functionally analogous to the pivoting link elements for supporting the axles of alternative front suspension designs. Such alternative designs are so rare that they are not specifically illustrated in this patent.

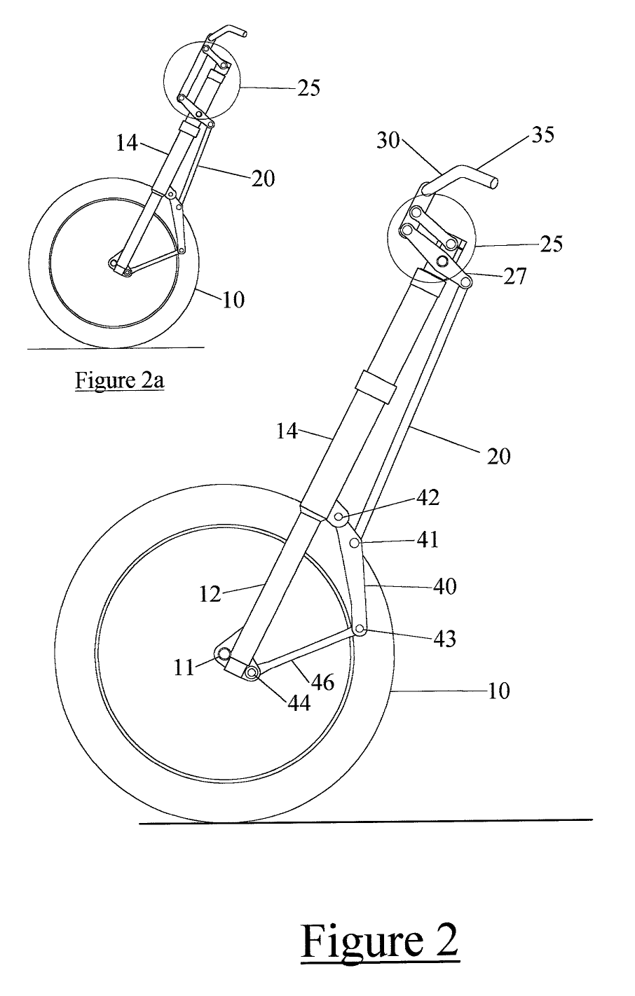

FIG. 2 shows a side elevational view of the front suspension and handlebar system of a two or three wheeled vehicle. The parallelogram linkage 25 which supports the handgrips 35 via the handlebar 30 is the same design shown in FIG. 1. Because the design of FIG. 1 did not significantly reduce the amplitude of the front suspension motion when transferring that motion to the parallelogram linkage 25, it was not practical for use with front wheel suspension systems that facilitated relatively long travel of the front wheel, such as off-road motorcycles. The design disclosed in FIG. 2 addresses that deficiency. FIG. 2 shows a front wheel 10 rotatively supported by an axle 11, which in turn is supported by a pair of fork sliders 12. A slider follower 46 is pivotally attached at lower slider follower pivot 44 to a fork slider 12 at one of its two distal ends. Slider follower 46 is also pivotally attached at its other distal end at intermediate link outboard pivot 43, to one end of intermediate link 40. The other end of intermediate link 40 is pivotally attached to an upper fork assembly tube 14. A lower connector link pivot 41 is located on intermediate link 40 between upper fork assembly tube pivot 42 and intermediate link outboard pivot 43, and pivotally connects intermediate link 40 with the lower end of connector link 20.

In FIG. 2, as in FIG. 1, connector link 20 is pivotally attached at its upper end to rear parallelogram link extension 27, so that a generally upward motion of connector link 20 results in a generally downward motion of handlebar 30 via parallelogram linkage 25, and vice versa.

When the front wheel 10 is displaced upward relative to the vehicle, in response to riding over a bump, or a similar event, fork slider 12 moves generally upwards toward upper fork assembly tube 14, thereby imparting rotational and translational motion to slider follower 46. In turn, said motion of slider follower 46 causes intermediate link 40, including lower connector link pivot 41, to rotate counterclockwise about upper fork assembly tube pivot 42, thereby imparting the upward motion to connector link 20 necessary for the corresponding downward motion of handlebar 30 and handgrips 35.

FIG. 2a is also a side elevational view of the front suspension and handlebar system of a two or three wheeled vehicle. It differs from FIG. 2 in the configuration and location of the parallelogram linkage 25. Lower parallelogram linkage element(s) 26 have been lowered relative to upper fork assembly tube 14, thereby facilitating a shorter connector link 20. This embodiment of the invention provides the benefit of keeping any part of the handlebar parallelogram linkage 25 actuation means, such as connector link 20, away from the area adjacent to the upper fork assembly tube 14 that could interfere with the main frame of the vehicle as the steering assembly is turned toward full lock on the side of any linkage components of the present invention.

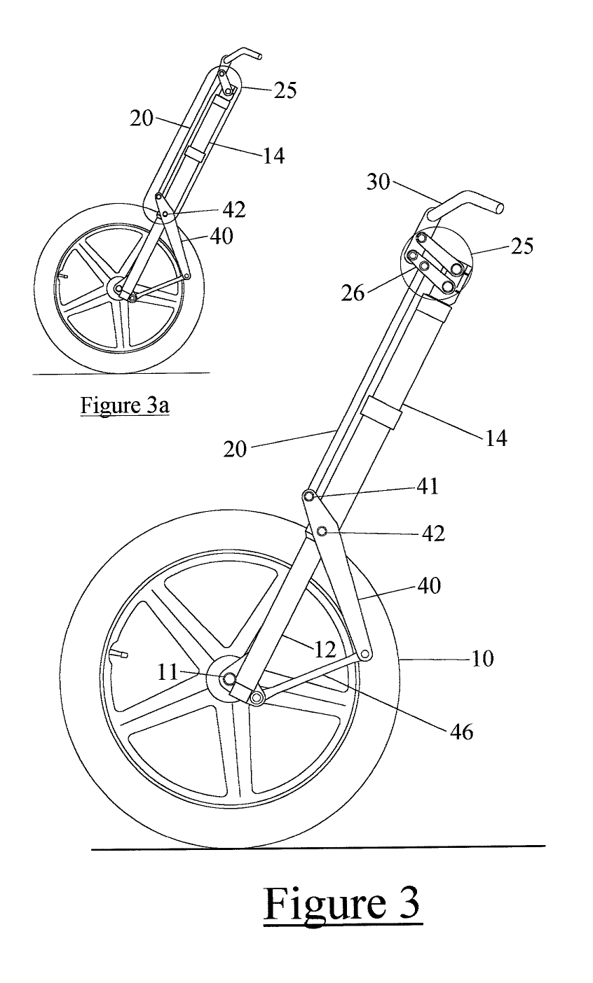

FIG. 3 shows a side elevational view of the front wheel suspension and handlebar system of a wheeled vehicle. In this figure, the slider 12 which supports an axle 11 upon which a front wheel 10 is rotatably supported, is moveable in and out of the upper fork assembly tube 14 in response to front suspension disturbances, as previously described As the front wheel 10 and fork slider 12 move generally upwards, intermediate link 40 rotates counterclockwise about upper fork assembly tube pivot 42, in response to the motion of slider follower 46, which itself, is pivotally connected to slider 12 at its lower end. In this preferred embodiment of the present invention, connector link 20 is positioned forward of upper fork assembly tube 14, with one corresponding benefit in particular being the elimination of potential interference of connector link 20 with the vehicle frame, fuel tank, etc., when the steering assembly is turned toward full lock. Connector link 20 is attached to intermediate link 40 at lower connector link 41. As intermediate link 40 rotates counterclockwise about upper fork assembly tube pivot 42 in response to upward motion of the front wheel 10 and its attached elements, it can be seen from this figure that lower connector link pivot 41 moves generally downward as does connector link 20. It can also be seen from this figure, that the upper end of connector link 20 is pivotally connected to the parallelogram linkage 25 which supports the handlebar 30. In this particular preferred embodiment connector link 20 is pivotally connected at its upper end to a lower parallelogram linkage element 26, although any connection location of the upper end of connector link 20 that causes the handgrips to move in response to the front suspension action is possible.

FIG. 3a shows a side elevational view of the front wheel suspension and handlebar system of a vehicle. The primary difference of this preferred embodiment and that of FIG. 3 is that the lower parallelogram linkage element 26 of FIG. 3 is replaced by the portion of intermediate link 40 that extends forward of upper fork assembly tube pivot 42. As such, connector link 20 and the upper fork assembly tube 14 become part of parallelogram linkage 25. A primary benefit of this embodiment of the present invention is the reduction in the number of bearings and other components in the system, with a corresponding reduction in its weight, complexity, and cost.

As in FIGS. 2 and 3, the alignment of pivots 41 and 42 relative to the longitudinal axis of connector link 20 influences the dynamic response of the handlebar to suspension system inputs.

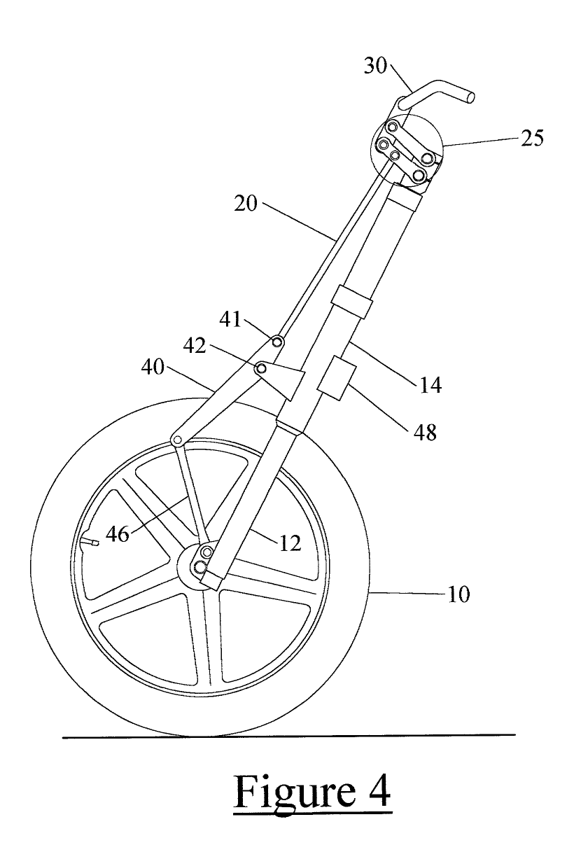

FIG. 4 shows another side elevational view of the front wheel suspension and handlebar suspension system The front suspension works as described in previous descriptions. In this preferred embodiment of the present invention, slider follower 46 is pivotally attached at its lower end to the fork slider 12 at a location forward of the fork slider 12. An intermediate link 40 is pivotally attached indirectly to the upper fork assembly tube 14, by a bracket mounted thereto, at an upper fork assembly tube pivot 42, which is also located between the distal ends of intermediate link 40. In this configuration, intermediate link 40 rotates clockwise about upper fork assembly tube pivot 42 as the front wheel 10 and fork slider 12 move toward the upper fork assembly tube 14. As intermediate link 40 initially rotates, lower connector link pivot 41 initially moves generally perpendicularly to the longitudinal axis of connector link 20, toward the rear of the vehicle. Until sufficient rotation of intermediate link 40 causes lower connector link pivot 41 to move significantly downward, there will be no appreciable downward motion of connector link 20 or any part of parallelogram linkage 25, or handlebar 30. The configuration of intermediate link 20 in this preferred embodiment facilitates a timing delay in the dynamic response of parallelogram linkage 25 and handlebar 30, in response to upward motion of the unsprung front suspension components. Said timing delay serves to make the handlebar actuation linkage non functional unless the degree of front wheel 10 suspension deflection becomes significant. Also shown on figure is displacement sensor 48 that can sense the displacement of the front suspension, as a function of time as necessary, and provide input to any variety of actuator types to move handlebar 30, thus affording a means of controlling the handlebar motion other than the previously mentioned linkage elements

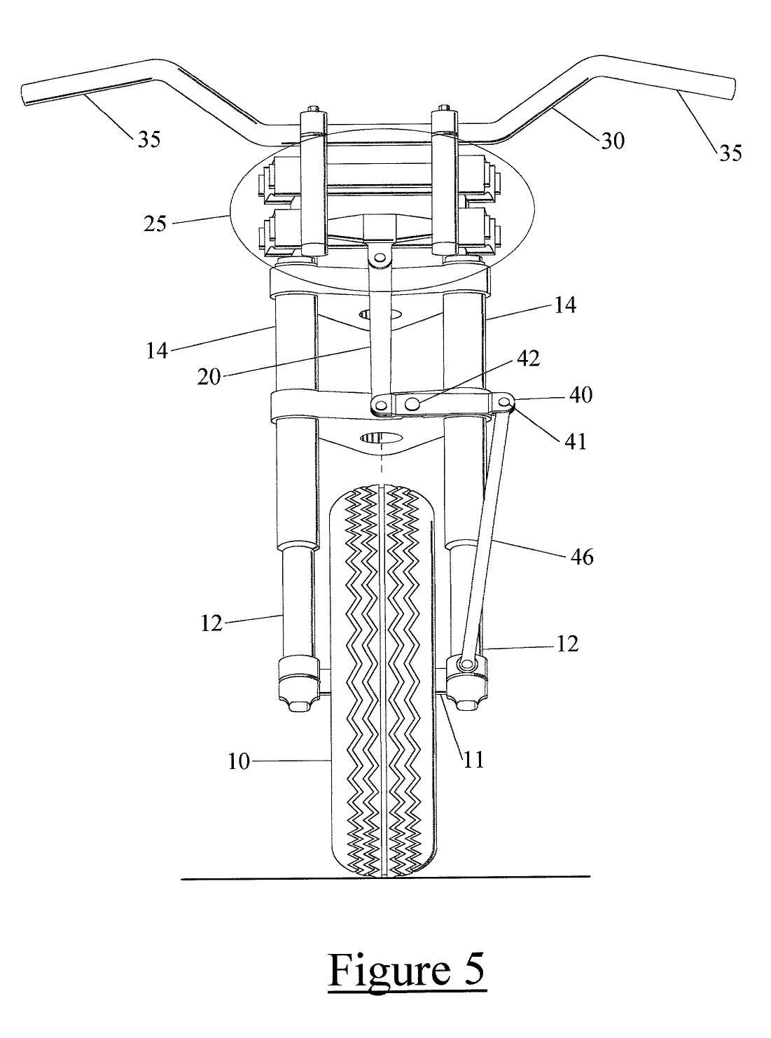

FIG. 5 shows a front elevational view of the front wheel and associated suspension system of a multi-wheeled vehicle. It includes a similar handlebar actuating linkage to the linkage of FIG. 3. Said linkage differs from the linkages of the prior figures in that it operates primarily in a plane perpendicular to the plane of the front wheel 10 As the wheel 10, along with the axle 11 and sliders 12 move generally upwards during normal front suspension operation, slider follower 46, which is pivotally attached to slider 12 at its lower end, conveys the generally vertical motion of the front wheel 10, to lower connector link pivot 41. In response to said motion conveyance, intermediate link 40 rotates counterclockwise about upper fork assembly tube pivot 42 as slider follower 46 moves upward, thereby imparting a downward motion to connector link 20, and to handlebar 30 and handgrips 35, via parallelogram linkage 25. It should be noted that although slider follower 46 is shown on the right side of the figure, and the left side of the vehicle, it could just as easily be located on the right side of the vehicle, as well as on both the right and left sides. Similarly, it could be located behind upper fork assembly tube 14 and fork slider 12, along with other linkage components. Since the location of linkage components of this invention relative to the existing suspension components of the prior art does not necessarily effect the performance of the linkage, it should be noted that all the linkages described herein could be repositioned at least somewhat, from the locations shown in the figures, without compromising their effectiveness.

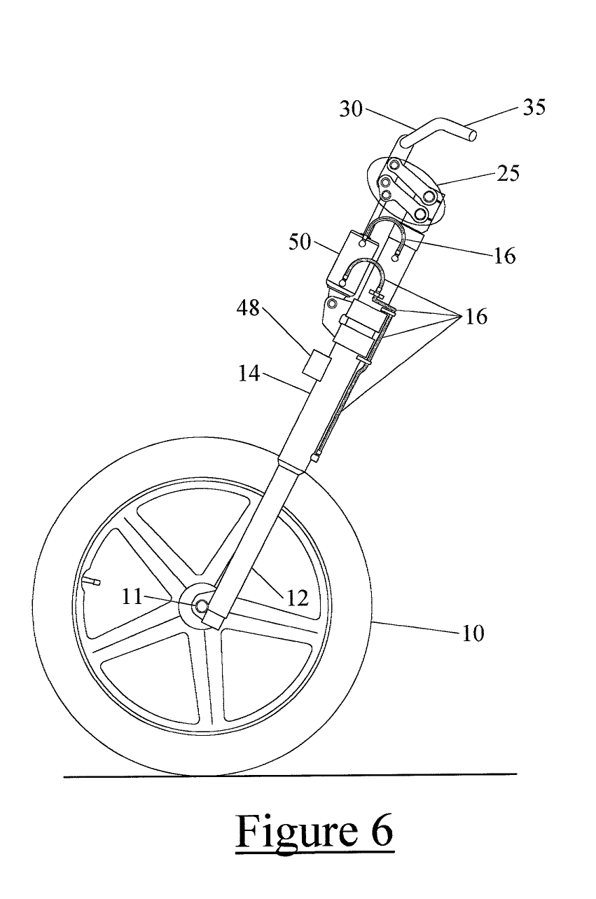

FIG. 6 shows a side elevational view of a front suspension system that includes a fluid means to control the position of handlebar 30 and/or the handgrips 35.

Internal to each fork slider 12, which supports a front wheel 10 via an axle 11, and associated upper fork assembly tube 14, is a spring and damper means wherein the spring is typically composed of a metal coil spring, an air spring, or an elastomeric device, and the damping means is typically composed of an internal piston attached either to the fork slider 12, or to the upper fork assembly tube 14, that can move back and forth within a sealed cylindrical cavity internal to the assembly composed of said fork slider 12 and upper fork assembly 14.

One or more working fluids also contained within said sealed cylindrical cavity internal to the assembly comprising fork slider 12 and upper fork assembly tube 14 are separated by said internal piston into at least two separate chambers. As fork slider 12 moves in or out of upper fork assembly tube 14, so too does said internal piston move further in or out of one of the two internal chambers on either side of it, within said internal cavity. In doing so, the forced motion of the fluid around and/or through said internal piston serves as a damping mechanism for the front suspension. Compression of the front suspension produces a flow of fluid from upper fork assembly tube 14 through the fluid transfer tubes 16, into and out of slave cylinder 50.

It is generally in this fashion that the motion of the front suspension pressurizes an internal working fluid which is used to power one or more slave cylinder type actuators 50 to control the vertical position of the handgrips 35. FIG. 6 shows a side elevational view of a front suspension system in which the slave cylinder type actuator 50 is mounted externally to the existing front suspension components. Slave cylinder type actuator 50 is pivotally mounted at its lower end to a bracket attached to upper fork assembly tube 14. The internal details of slave cylinder type actuator 50, including a preferred centering spring, are not shown. The slave cylinder type actuator 50 actuator rod in FIG. 6 is shown pivotally attached to a parallelogram handlebar mounting linkage 25. It is also possible to utilize a telescoping actuator such as slave cylinder type actuator 50 without a separate parallelogram linkage 25, to support the handlebar or handgrips. Furthermore, it is possible to construct upper fork assembly tube 14 with a slave cylinder contained internally. It should be noted that the actuator shown in FIG. 6 could also rely on electromechanical power instead of fluid power, when used in conjunction with an electrical power source, a front suspension displacement sensor 48, and optionally, an electrical circuit for properly coordinating the displacement of the handlebar 30 via said actuator with the displacement of the front wheel 10.

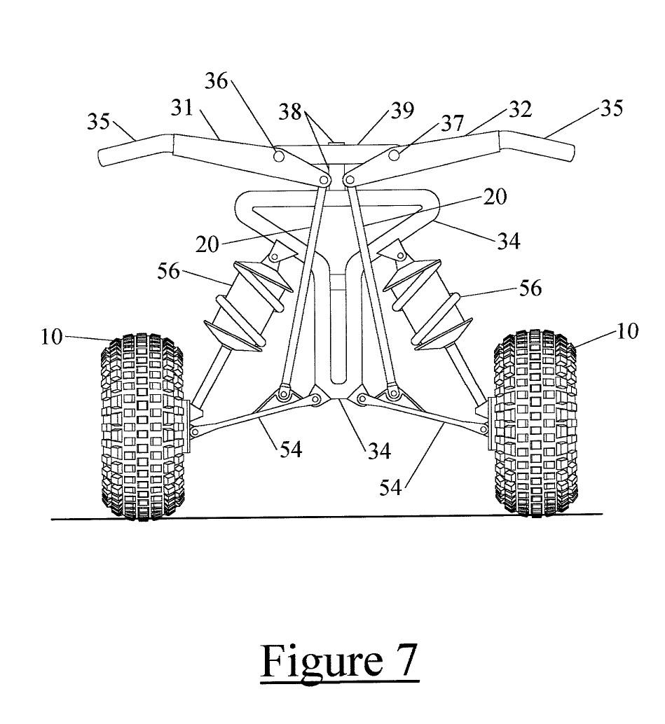

FIG. 7 is a front elevational view of an ATV with two front wheels. Each front wheel 10 has a suspension system comprising a shock absorber assembly 56 and a control arm 54, each of which is pivotally attached at one of its ends to a bracket on the main vehicle frame 34. While many ATVs utilize multiple control arms to suspend each wheel, only one control arm 54 per wheel is shown in FIG. 7. The selection of control arm 54 as an attachment point for connector link 20 was arbitrary except for the fact that control arm 54 moves when wheel 10 moves. Pivotally attached to each control arm 54 at a point between its distal ends, is the lower end of a connector link 20.

Said suspension system allows the front wheel 10 to travel in a generally vertical path in response to suspension input. A steering shaft 38 is secured by main frame 34 in such a way that it can rotate about its generally vertical longitudinal axis. Rigidly attached to the upper portion of steering shaft 38 is a handlebar mounting bracket 39, which supports right handlebar mounting pivot 36 at its right lateral outboard end, and left handlebar mounting bracket 37 at its left lateral outboard end. Said handlebar mounting bracket 39 also rotates with steering shaft 38 about the longitudinal axis of steering shaft 38. Right and left handlebars 31 and 32, are pivotally attached to right handlebar mounting pivot 36 and to left handlebar mounting pivot 37, respectively, so as to allow rotation through an arc, of each handlebar 31 and 32, about their handlebar mounting pivots 36 and 37, respectively, when viewed from the front of the vehicle. Inboard of each handlebar mounting pivot on each handlebar, is a pivot for connecting the upper end of each connector link 20 to the right and left handlebars 31 and 32.

During the operation of the vehicle, events occur causing one or both wheels 10 to move vertically upwards relative to the main vehicle frame 34, compressing the shock absorber assembly 56 in the process. When the wheels 10 move vertically upward relative to the main vehicle frame 34, so too do the outboard ends of the control arms 54. To a lesser degree, each connector link 20, which is attached at its lower end to its corresponding control arm 54, also moves vertically upward relative to the main vehicle frame 34. As this happens, the upper end of each connector link 20 causes a generally upward motion of the inboard end of its corresponding handlebar 31 or 32, about its associated handlebar mounting pivot 36 or 37. When the inboard ends of each handlebar move upward, there is a corresponding downward motion of the outboard end of each handlebar. Because handgrips 35 are attached to the outboard end of each handlebar, they too move generally downward in response to upward motion of wheels 10 and connector links 20, to fulfill the purpose of the present invention.

While the parallelogram linkages for mounting the handlebars of previous embodiments are replaced in the preferred embodiment disclosed in FIG. 7, by simple pivots 36 and 37, it is still possible to use a parallelogram or other four bar linkage to mount each handlebar 31 and 32, to a bracket attached to steering shaft 38, without diminishing the basic functionality of the linkage means of this invention. Conversely, the right and left handlebars 31 and 32, could be utilized on previously disclosed embodiments, instead of a one piece handlebar that supports both handgrips 35. Also, the linkages for connecting the motion of the front wheels to the handlebars of the previously disclosed embodiments, or combinations of said linkages, as well as other linkages, could be utilized instead of the particular linkage of FIG. 7.

One such linkage in particular would include a double ended laterally transverse link with each distal end pivotally attached to a moveable member of the front wheel suspension system, such as control arm 54, or to a bracket or fixture attached thereto. A single connector link would then convey an averaged upward motion of the right and left front suspension systems via said double ended laterally transverse link, to the handlebar, or to a linkage supporting said handlebar, or to an intermediate linkage or other means directly or indirectly coupled to said handlebar.

I claim:

1. A suspension system for a vehicle having a main frame, a handlebar and a front wheel, the suspension system comprising:
a linkage connecting the front wheel with respect to the handlebar for moving the handlebar relative to the main frame responsive to movement of the front wheel relative to the main frame.

2. The suspension system of claim 1 wherein the linkage is reversibly operable to provide that upward movement of the front wheel relative to the main frame causes a related displacement of the handlebar relative to the main frame.

3. The suspension system of claim 2 wherein the related displacement of the handlebar is dampened relative to the upward movement of the front wheel.

4. The suspension system of claim 1 wherein the linkage comprises:
a four bar link moveably supporting the handlebar relative to the main frame.

5. The suspension system of claim 1 wherein the linkage comprises:
a double ended link for moveably supporting the handlebar relative to the main frame.

6. The suspension system of claim 1 wherein the linkage comprises:
at least one fork slider connecting the front wheel with respect to the main frame; and
a connector link connecting the at least one fork slider with respect to the handlebar.

7. The suspension system of claim I wherein the linkage comprises:
one or more cylinders connected with respect to the front wheel and the handle bar;
a working fluid contained in the one or more cylinders transferring movement of the front wheel to movement of the handlebar.

8. The suspension system of claim 1 further comprising:
a right handlebar moveably attached to the main frame;
a left handlebar moveably attached to the main frame, the right handlebar and the left handlebar each independently moveable relative to the main frame.

9. The suspension system of claim 1 further comprising:
a displacement sensor connected with respect to the linkage for determining a displacement of the front wheel;
an actuator connected with respect to the linkage to control a position of the handlebar based on input from the displacement sensor.

10. The suspension system of claim 9 wherein at least one of the actuator and the displacement sensor are adjustable to provide adjustable movement of the handlebar relative to the main frame responsive to movement of the front wheel relative to the main frame.

11. A suspension system for a vehicle having a main frame, a handlebar, a fork and a front wheel, the suspension system comprising:
at least one fork slider positioned within the fork and moveably connecting the front wheel with respect to the main frame;
a four bar link moveably supporting the handlebar relative to the main frame;
a connector link connecting the at least one fork slider with respect to the four bar link for moving the handlebar relative to the main frame responsive to movement of the front wheel relative to the main frame.

12. The suspension system of claim 11 further wherein the connector link is configured to dampen movement of the handlebar relative to movement of the front wheel.

13. The suspension system of claim 11 wherein the four bar link comprises a parallelogram link having two pivoting connections with respect to a stem of the main frame and two opposite pivoting connections with respect to the handlebar.

14. The suspension system of claim 11 wherein the connector link is pivotally connected to the at least one fork slider.

15. The suspension system of claim 11 wherein the connector link includes at least one intermediate link pivotally connecting the connector link with respect to the four bar link.

16. The suspension system of claim 11 wherein the connector link is pivotally connected with respect to the fork.

17. A suspension system for a vehicle having a main frame, a handlebar and a fork, the suspension system comprising:
at least one fork slider slideably positioned within the fork;
a four bar link moveably supporting the handlebar relative to the main frame;
a connector link connecting one of the fork and the at least one fork slider with respect to the four bar link for moving the handlebar relative to the main frame responsive to movement of one of the fork and the at least one fork slider relative to the main frame.

18. The suspension system of claim 17 wherein one of the fork and the at least one fork slider is arranged to receive one of a ski, a wheel and a float.

19. The suspension system of claim 17 wherein the connector link is pivotally connected to the fork.

20. The suspension system of claim 17 wherein handlebar moves downwardly in a vertical direction a corresponding amount as the fork slider moves within the fork.
